(19) United States
(12) Patent Application Publication
(10) Pub. No.: US 2026/0334745 A1
(43) Pub. Date: Oct. 29, 2026

(54) CLEANING DEVICE CONTROL METHOD, CLEANING DEVICE, AND SYSTEM

(71) Applicant: Dreame Innovation Technology (Suzhou) Co., Ltd., Suzhou (CN)

(72) Inventors: Jiajia Sun, Suzhou (CN); Shaohan Luo, Suzhou (CN); Shuai Du, Suzhou (CN); Sirui Xun, Suzhou (CN)

(21) Appl. No.: 19/701,477

(22) Filed: Jun. 8, 2026

Related U.S. Application Data
(63) Continuation of application No. PCT/CN2025/116775, filed on Aug. 25, 2025.

(30) Foreign Application Priority Data
Sep. 14, 2024 (CN) 202411295690.8

(51) Int. Cl. A47L 11/40; A47L 9/28; G05D 1/648; G05D 105/10

(52) U.S. Cl. CPC A47L 11/4011; A47L 9/2847; A47L 9/2852; A47L 9/2857; A47L 11/4002; G05D 1/648; A47L 2201/04; A47L 2201/06; G05D 2105/10

(57) ABSTRACT

A cleaning device control method, a cleaning device, and a system, where the cleaning device control method includes: receiving a first control instruction during execution of a current cleaning task, where the first control instruction is an instruction for performing supplementary cleaning on a designated area within a work area which has been cleaned in the current cleaning task, the designated area is an area defined on a display interface of a smart terminal, and the smart terminal is communicatively connected to the cleaning device; and controlling, on the basis of the first control instruction, the cleaning device to travel to the designated area to perform supplementary cleaning on the designated area.

### CROSS-REFERENCE TO RELATED DISCLOSURES

The present application is a continuation of International Application No. PCT/CN2025/116775, filed on Aug. 25, 2025, which claims the priority to Chinese Patent Application No. 202411295690.8, filed with the China National Intellectual Property Administration on Sep. 14, 2024 and entitled “CLEANING DEVICE CONTROL METHOD, CLEANING DEVICE, AND SYSTEM”. The disclosures of the aforementioned applications are hereby incorporated by reference in their entireties.

### TECHNICAL FIELD

The present application relates to the technical field of cleaning devices, and in particular to a cleaning device control method, a cleaning device, and a system.

### BACKGROUND

In household and commercial settings, smart cleaning devices have become increasingly prevalent. The smart cleaning devices automatically execute cleaning tasks based on preset cleaning schedules, significantly reducing the burden of household chores. However, during execution of cleaning tasks, existing smart cleaning devices still have some limitations, particularly in coping with unexpected situations and changing requirements.

In the related art, when a cleaning device executes a cleaning task, a cleaning schedule can only be determined before the cleaning task begins. Once the cleaning task is started, the cleaning schedule can only be executed strictly according to the predetermined sequence, and cannot flexibly cope with sudden changes in requirements during the task, for example, cannot flexibly cope with an unexpected situation where cleaning of a certain area is temporarily skipped or cleaning of a certain area is temporarily required.

The above situation leads to poor cleaning flexibility. In case of unexpected situations, the cleaning schedule can only be reconfigured at the end of the task, and temporary requirements of a user cannot be responded to in a timely manner, thereby leading to a decline in the cleaning effect and user satisfaction.

### SUMMARY

The present application provides a cleaning device control method, a cleaning device, and a system, such that a user can adjust a cleaning schedule of the cleaning device in real time according to actual situations, to flexibly cope with unexpected situations, thereby improving the cleaning effect and user satisfaction.

In a first aspect, the present application provides a cleaning device control method for a controller of a cleaning device, the method including:
receiving a first control instruction during execution of a current cleaning task, where the first control instruction is an instruction for performing supplementary cleaning on a designated area within a work area which has been cleaned in the current cleaning task, the designated area is an area defined on a display interface of a smart terminal, and the smart terminal is communicatively connected to the cleaning device; and
controlling, on the basis of the first control instruction, the cleaning device to travel to the designated area to perform supplementary cleaning on the designated area.

In this way, a user can adjust the work area of the cleaning device in real time according to actual situations to flexibly cope with unexpected situations in family life. In particular, the user can detect and handle the area where supplementary cleaning needs to be performed in a timely manner. The designated area can be sufficiently cleaned through the supplementary cleaning. In the present application, the user can conveniently control the cleaning device by means of the smart terminal, to perform targeted cleaning on the designated area, thereby enhancing user satisfaction and user experience.

In an implementation, upon completion of the supplementary cleaning of the designated area, the cleaning device is controlled to continue to travel to a work area, which has not been cleaned during the current cleaning task, to perform cleaning.

In this way, the cleaning device can automatically continue the unfinished cleaning task upon the completion of the supplementary cleaning, to ensure the continuity and efficiency of the entire cleaning process, thereby improving the cleaning efficiency.

In an implementation, the designated area is an area where the degree of soiling is greater than a preset threshold.

In this way, the user can adjust the work area of the cleaning device at any time according to actual situations to flexibly cope with unexpected situations in family life. In particular, the user can detect and handle the area where the degree of soiling is greater than the preset threshold in a timely manner. It is possible to ensure that all areas achieve the cleaning effect desired by the user through the re-cleaning operation, thereby improving the overall cleaning quality. In the present application, the user can conveniently control the cleaning device by means of the smart terminal, to ensure that the cleaning effect meets expectations, thereby enhancing user satisfaction and user experience.

In an implementation, the cleaning device includes a cleaning assembly and a main body; the cleaning assembly has a first position and a second position; a part of the cleaning assembly that is located outside a peripheral side of the main body when in the second position is larger than a part of the cleaning assembly that is located outside the peripheral side of the main body when in the first position; the designated area is an area where the cleaning assembly of the cleaning device does not enter when in the second position; and
controlling, on the basis of the first control instruction, the cleaning device to travel to the designated area to perform supplementary cleaning on the designated area includes: controlling, on the basis of the first control instruction, the cleaning device to travel to the designated area, and controlling the cleaning assembly of the cleaning device to switch from the second position to the first position to perform supplementary cleaning on the designated area.

In this way, for an area where the cleaning assembly of the cleaning device cannot performing cleaning when in a previous working mode, it is determined, upon user confirmation, that changing the position of the cleaning assembly of the cleaning device allows access to this area for cleaning, so that the user can adjust the working mode of the cleaning device at any time according to actual situations, thereby ensuring that no cleaning area is missed, and guaranteeing the comprehensiveness and thoroughness of the cleaning task, especially in complex environments.

In an implementation, performing supplementary cleaning on the designated area includes:
receiving a supplementary cleaning strategy sent by the smart terminal, or identifying cleaning requirements for the designated area and determining a supplementary cleaning strategy on the basis of the cleaning requirements; and
performing supplementary cleaning on the designated area on the basis of the supplementary cleaning strategy.

In this way, the user can select or set up the supplementary cleaning strategy according to his/her need and preference, enabling a personalized cleaning scheme. Alternatively, by determining the supplementary cleaning strategy on the basis of the cleaning requirements, it is possible to ensure that the designated area is most suitable for cleaning treatment, improving the cleaning effect. Thus, the user can adjust the supplementary cleaning strategy flexibly, and the cleaning device can also automatically identify the cleaning requirements, to flexibly cope with different cleaning scenarios.

In an implementation, the first control instruction is a one-shot control instruction.

In this way, the one-shot control instruction avoids the complexity of the persistent setting, eliminating user concerns about long-term impacts on the working path of the cleaning device, so that the user only has to send the first control instruction when necessary, thereby enabling simple operation and enabling on-demand control over the cleaning device to perform supplementary cleaning on the designated area at any time.

In an implementation, the method further includes:
storing the first control instruction, so as to directly invoke the first control instruction the next time the designated area is encountered.

In this way, there is no need for the user to manually set the designated area to undergo supplementary cleaning each time, saving time and effort and improving operational efficiency. The user can also conveniently invoke the previously stored instruction, thereby enabling simple operation, and the stored control instruction can be quickly invoked, thereby simplifying the operational steps of the user, and enhancing user experience and satisfaction.

In a second aspect, the present application provides a cleaning device control method for a controller of a cleaning device, the method including:
receiving a second control instruction during execution of a current cleaning task, where the second control instruction is an instruction for avoiding a specific area, the specific area is an area defined on a display interface of the smart terminal that does not require cleaning, and the smart terminal is communicatively connected to the cleaning device; and
controlling, on the basis of the second control instruction, the cleaning device to avoid the specific area.

Therefore, the user can adjust the work area of the cleaning device in real time according to actual situations to flexibly cope with unexpected situations in family life, enhancing the intelligence and adaptability of the cleaning device. In particular, the user can conveniently control the cleaning device to avoid the specific area by means of the smart terminal, thereby enabling simple operation, and enhancing user experience and satisfaction. In the present application, the cleaning device may, in response to the control instruction generated by the smart terminal, avoid an occupied area during execution of the cleaning task by the cleaning device, preventing the cleaning device from entering the occupied area, reducing interference to people and pets, avoiding potential collision and injury risks, avoiding areas that do not require cleaning, reducing the operating time and energy consumption of the cleaning device, and prolonging battery life and the overall service life of the cleaning device.

In an implementation, the second control instruction is a one-shot control instruction.

In this way, the one-shot control instruction avoids the complexity of the persistent setting, eliminating user concerns about long-term impacts on the working path of the cleaning device, so that the user only has to send the second control instruction when necessary, thereby enabling simple operation and enabling on-demand control for controlling the cleaning device to avoid the specific area at any time.

In an implementation, the method further includes:
storing the second control instruction, so as to directly invoke the second control instruction the next time the specific area is encountered.

In this way, there is no need for the user to manually set the area to be avoided each time, saving time and effort and improving operational efficiency. The user can also conveniently invoke the previously stored instruction, thereby enabling simple operation, and the stored control instruction can be quickly invoked, thereby simplifying the operational steps of the user, and enhancing user experience and satisfaction.

In a third aspect, the present application provides a cleaning device control method for a controller of a cleaning device, the method including:
receiving a third control instruction during execution of a current cleaning task, where the third control instruction is an instruction for performing focused cleaning on a first area, the first area is an area defined on a display interface of the smart terminal that requires intensified cleaning, and is an area being cleaned or an uncleaned area, and the smart terminal is communicatively connected to the cleaning device; and
controlling, on the basis of the third control instruction, the cleaning device to clean the first area a plurality of times.

In this way, the user can adjust the work area of the cleaning device at any time according to actual situations to flexibly cope with unexpected situations in family life. In particular, the user can perform focused cleaning on stubborn stains or high-traffic areas. It is possible to ensure that the focused area is thoroughly cleaned through multiple cleaning operations, thereby improving the overall cleaning quality. In the present application, the user can conveniently control the cleaning device by means of the smart terminal, to ensure that the cleaning effect meets expectations, thereby enhancing user satisfaction and user experience.

In an implementation, the third control instruction is a one-shot control instruction.

In this way, by using the one-shot third control instruction, the user can flexibly and conveniently control the cleaning device to clean the first area a plurality of times, ensuring efficient, safe and personalized execution of the cleaning task. Moreover, the one-shot control instruction avoids the complexity of the persistent setting, eliminating user concerns about long-term impacts on the working path of the cleaning device, and the one-shot control instruction ensures that the cleaning device only performs re-cleaning in the current task, saving time and resources.

In an implementation, the method further includes:
storing the third control instruction, so as to directly invoke the third control instruction the next time the first area is encountered.

In this way, there is no need for the user to manually set the first area to undergo multiple cleanings each time, saving time and effort and improving operational efficiency. The user can also conveniently invoke the previously stored instruction, thereby enabling simple operation, and the stored control instruction can be quickly invoked, thereby simplifying the operational steps of the user, and enhancing user experience and satisfaction.

In a fourth aspect, the present application provides a cleaning device control method for a controller of a cleaning device, the method including:
receiving a fourth control instruction during execution of a current cleaning task, where the fourth control instruction is an instruction for performing temporary cleaning on a second area, the second area is an area defined on a display interface of a smart terminal, and the smart terminal is communicatively connected to the cleaning device; and
controlling, on the basis of the fourth control instruction, the cleaning device to perform temporary cleaning on the second area.

Therefore, the user can temporarily adjust the cleaning sequence according to actual situations to flexibly cope with unexpected situations in family life. It is possible to ensure timely cleaning of a focused area by prioritizing the cleaning of the second area, thereby improving the overall cleaning efficiency. Moreover, the temporal adjustment of the order of the second area in the cleaning sequence can prevent the cleaning device from cleaning the specific area at an inappropriate time, thereby improving the safety and comfort of family members. In the present application, the user can conveniently control the cleaning device by means of the smart terminal, to ensure that the cleaning effect meets expectations, thereby enhancing user satisfaction and user experience.

The fourth control instruction is a one-shot control instruction.

In this way, by using the one-shot fourth control instruction, the user can flexibly and conveniently control the cleaning device to adjust the order of the second area in the cleaning sequence, ensuring efficient, safe and personalized execution of the cleaning task. Moreover, the one-shot control instruction avoids the complexity of the persistent setting, eliminating user concerns about long-term impacts on the working path of the cleaning device, and the one-shot control instruction ensures that the cleaning device only performs re-cleaning in the current task, saving time and resources.

In an implementation, the method further includes:
storing the fourth control instruction, so as to directly invoke the fourth control instruction the next time the second area is encountered.

In this way, there is no need for the user to manually set the order of the second area in the cleaning sequence each time, saving time and effort and improving operational efficiency. The user can also conveniently invoke the previously stored instruction, thereby enabling simple operation, and the stored control instruction can be quickly invoked, thereby simplifying the operational steps of the user, and enhancing user experience and satisfaction.

In an implementation, controlling, on the basis of the fourth control instruction, the cleaning device to perform temporary cleaning on the second area includes:
determining a third area corresponding to the execution of the current cleaning task, the third area including at least an uncleaned area;
determining the second area for temporary cleaning on the basis of the fourth control instruction; and
adjusting a cleaning sequence to prioritize the second area over the third area, so as to perform temporary cleaning on the second area.

Therefore, by adjusting the order of the second area in the cleaning sequence, it is possible to ensure that a critical area is cleaned in a timely and prioritized manner. In an implementation, after the second area has been first cleaned, the cleaning device can still proceed to clean the third area, ensuring that all uncleaned areas are cleaned.

In an implementation, performing temporary cleaning on the second area includes:
receiving a cleaning strategy sent by the smart terminal, and performing temporary cleaning on the second area on the basis of the cleaning strategy, the cleaning strategy being determined on the basis of temporary requirements from a user.

In this way, the user specifies the cleaning strategy for the second area, such that a personalized, targeted and efficient cleaning of the second area can be achieved, ensuring that the cleaning task meets current requirements.

In an implementation, the defined area is determined by a touch operation of a user on the display interface of the smart terminal, the touch operation including any one of the following: a frame selection operation, a single tap operation, a double tap operation, a long press operation, a swipe operation, a drag and drop operation, and a multi-finger operation.

Therefore, by performing the various touch operations described above on the display interface, the user can flexibly and conveniently determine the designated area requiring supplementary cleaning, the specific area, the first area, and the second area.

In an implementation, the display interface includes at least a cleaning map; the cleaning map includes a plurality of cleaning areas; and each cleaning area is capable of displaying a cleaning status for a user to view.

In this way, the user can monitor the progress of the cleaning task in real time through the display interface, understand the cleaning status of each area, and adjust the work area of the cleaning device at any time according to actual situations, to flexibly cope with unexpected situations in family life. The display interface is intuitive and user-friendly, enabling the user to operate it conveniently, thereby enhancing user experience and satisfaction.

In a fifth aspect, the present application provides a cleaning device, including: a controller for executing the control method of any one item of the first aspect to the fourth aspect, a cleaning assembly, and a main body.

The cleaning device provided in the present application, through the integrated design of a controller for executing various control methods, a cleaning assembly and a main body, not only improves the cleaning effect and user experience, but also enables flexible adjustment of the cleaning schedule of the cleaning device according to different user's needs.

In a sixth aspect, the present application provides a cleaning device control system, including: a cleaning device and a smart terminal, where the cleaning device includes a controller for executing the control method of any one item of the first aspect to the fourth aspect;
the smart terminal is communicatively connected to the cleaning device; and the smart terminal is configured to send a control instruction to the controller.

Therefore, with such a cleaning device control system, the user can conveniently generate a control instruction by operating the smart terminal, to flexibly adjust the cleaning schedule and strategy of the cleaning device during the execution of the cleaning task, thereby not only enhancing the operational convenience and flexibility but also ensuring that the user can flexibly adjust the cleaning schedule of the cleaning device according to actual requirements and preferences, thereby ensuring that the cleaning task meets current requirements.

In an implementation, the control instruction is determined from a type of area selected by a user on a display interface of the smart terminal.

In this way, for different cleaning requirements of the user, the type of control instruction generated can be determined by selecting the type of area to be cleaned or avoided on the display interface of the smart terminal, to control the cleaning device to perform different actions.

In a seventh aspect, the present application provides an electronic device, including: a processor, and a memory communicatively connected to the processor, where
the memory is configured to store computer-executable instructions; and
the processor is configured to execute the computer-executable instructions stored in the memory, to implement the method of any one item of the first aspect to the fourth aspect.

In an eighth aspect, the present application provides a non-transitory computer-readable storage medium. The non-transitory computer-readable storage medium stores computer-executable instructions. The computer-executable instructions, when executed by a processor, are configured to implement the method of any one item of the first aspect to the fourth aspect.

In a ninth aspect, the present application provides a computer program product, including a computer program. The computer program, when executed by a processor, implements the method of any one item of the first aspect to the fourth aspect.

In summary, the present application provides a cleaning device control method, a cleaning device, and a system, in which the cleaning schedule of the cleaning device can be adjusted in real time, to specifically cope with unexpected situations encountered during the cleaning task, such as temporarily avoiding cleaning for a certain area, temporarily requiring cleaning for a certain area, or performing focused cleaning, re-cleaning, or supplementary cleaning on a certain area. Upon receiving the control instruction generated by the user operating the smart terminal, the cleaning device can be controlled, on the basis of the control instruction, to perform corresponding actions, such as controlling the cleaning device to avoid a specific area, controlling the cleaning device to travel to a designated area to perform supplementary cleaning on the designated area, controlling the cleaning device to perform clean a first area a plurality of times, and controlling the cleaning device to perform temporary cleaning on a second area, so that the user can dynamically adjust the cleaning schedule according to actual situations, to cope with unexpected situations, thereby increasing the flexibility to execute the cleaning task.

### BRIEF DESCRIPTION OF DRAWINGS

The drawings herein, which are incorporated into the specification and constitute a part of the specification, illustrate embodiments that conform to the present application and are used together with the specification to explain the principles of the present application.

FIG. 1 is a schematic diagram of an application scenario according to an embodiment of the present application.

FIG. 2 is a schematic flowchart of a cleaning device control method according to an embodiment of the present application.

FIG. 3 is a schematic flowchart of another cleaning device control method according to an embodiment of the present application.

FIG. 4 is a schematic flowchart of still another cleaning device control method according to an embodiment of the present application.

FIG. 5 is a schematic flowchart of yet another cleaning device control method according to an embodiment of the present application.

FIG. 6 is a structural schematic diagram of a cleaning device control apparatus according to an embodiment of the present application.

FIG. 7 is a structural schematic diagram of another cleaning device control apparatus according to an embodiment of the present application.

FIG. 8 is a structural schematic diagram of still another cleaning device control apparatus according to an embodiment of the present application.

FIG. 9 is a structural schematic diagram of yet another cleaning device control apparatus according to an embodiment of the present application.

FIG. 10 is a structural schematic diagram of an electronic device according to an embodiment of the present application.

Specific embodiments of the present application have been shown by the drawings, which are described below in more detail. These drawings and textual description are not intended to limit the scope of the concept of the present application in any way, but rather to illustrate the concept of the present application for a person skilled in the art by reference to specific embodiments.

### DESCRIPTION OF EMBODIMENTS

In order to facilitate clear description of the technical solutions of embodiments of the present application, in embodiments of the present application, terms such as “first” and “second” are used to distinguish between same items or similar items having substantially the same function and role. For example, a first device and a second device are merely intended to distinguish between different devices and do not limit their sequential order. A person skilled in the art may understand that the terms such as “first” and “second” do not define a number or an execution sequence, and the terms such as “first” and “second” do not indicate a definite difference.

It should be noted that in the present application, the words “for example” or “such as” are used as examples, illustrations, or descriptions. Any embodiment or design described as “for example” or “such as” in the present application shall not be construed as more preferred or advantageous over other embodiments or designs. Specifically, the use of words such as “for example” or “such as” is intended to present relevant concepts in a concrete manner.

In the present disclosure, “at least one” means one or more, and “a plurality of” means two or more. “And/or” is used to describe an association relationship between associated objects, which indicates that three relationships may exist. For example, A and/or B may indicate that only A exists, both A and B exist, or only B exists, where A or B may be singular or plural. The character “/” generally indicates an “or” relationship between the associated objects. “At least one of the following items” or a similar expression is any combination of these items, including a single item or any combination of a plurality of items. For example, at least one of a, b, or c may indicate a, b, c, a-b, a-c, b-c, or a-b-c, where a, b, or c may be singular or plural.

In view of the fact that when an existing cleaning device executes a cleaning task, a cleaning schedule can only be determined before the cleaning task begins, and once the cleaning task is started, the cleaning schedule can only be executed strictly according to the predetermined sequence, and cannot flexibly cope with sudden changes in requirements during the task, the present application provides a cleaning device control method, in which the cleaning schedule for the cleaning device can be adjusted in real time, to specifically cope with unexpected situations encountered during the cleaning task, such as temporarily avoiding cleaning for a certain area, temporarily requiring cleaning for a certain area, or performing focused cleaning, re-cleaning, or supplementary cleaning on a certain area. Upon receiving the control instruction generated by the user operating the smart terminal, the cleaning device can be controlled, on the basis of the control instruction, to perform corresponding actions, such as controlling the cleaning device to avoid a specific area, controlling the cleaning device to travel to a designated area to perform supplementary cleaning on the designated area, controlling the cleaning device to perform clean a first area a plurality of times, and controlling the cleaning device to perform temporary cleaning on a second area, so that the user can dynamically adjust the cleaning schedule according to actual situations, to cope with unexpected situations, thereby increasing the flexibility to execute the cleaning task.

By way of example, an embodiment of the present application provides a cleaning device, including: a controller, a cleaning assembly, and a main body. The controller is configured to execute any one of the cleaning device control methods according to the embodiments of the present application.

The cleaning assembly has a first position and a second position. A part of the cleaning assembly that is located outside a peripheral side of the main body when in the second position is larger than a part of the cleaning assembly that is located outside the peripheral side of the main body when in the first position. In this way, the width, on a horizontal plane, of the cleaning device corresponding to the cleaning assembly in the second position is greater than the width of the cleaning device corresponding to the cleaning assembly in the first position.

The cleaning assembly may be a mop assembly, a side brush assembly, etc., and the type and number of cleaning assemblies are not specifically limited in the embodiments of the present application.

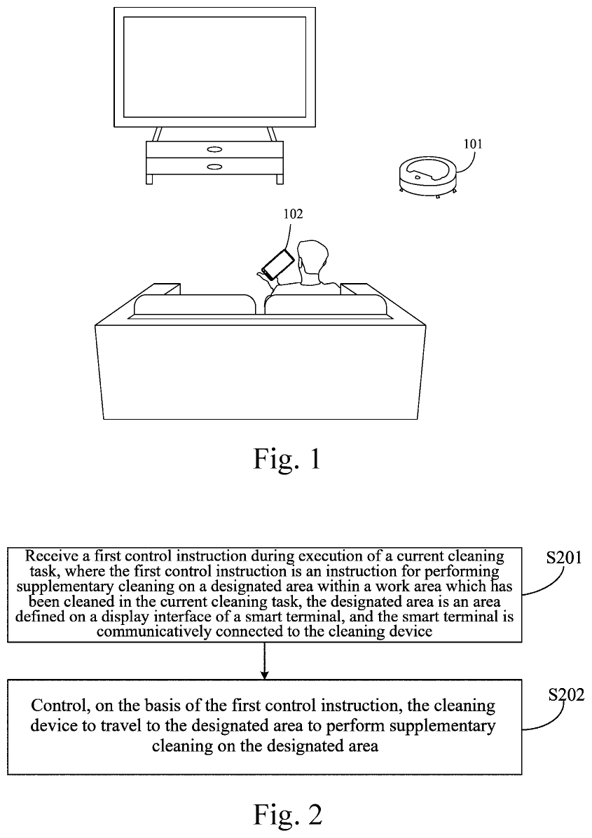

By way of example, FIG. 1 is a schematic diagram of an application scenario according to an embodiment of the present application. Taking a home scenario as an example, the application scenario includes: a cleaning device 101 and a smart terminal 102 of a user. The cleaning device 101 and the smart terminal 102 establish a communicative connection for real-time communication.

When the user is resting in a living room, the cleaning device 101 may be activated to cause the cleaning device 101 to clean the entire house. During execution of a cleaning task by the cleaning device, the user can view the cleaning status of the cleaning device 101 by means of the smart terminal 102 and send a control instruction to the controller of the cleaning device 101 by means of the smart terminal 102, to control the cleaning device 101 to perform corresponding actions.

In an implementation, when the user finds that a child is playing in the living room, a control instruction may be sent to the controller of the cleaning device 101 by means of the smart terminal 102 such that the cleaning device avoids the living room area and cleans other areas during the execution of the cleaning task, so that the child can play freely in the living room, without being disturbed by the operation of the cleaning device 101, and the safety of the child can also be guaranteed.

In an implementation, when the user finds that a corner in the living room has not been cleaned, a control instruction may be sent to the controller of the cleaning device 101 by means of the smart terminal 102 such that the cleaning device returns to the corner for cleaning during the execution of the cleaning task. In this way, the problem area can be remedied during the cleaning task, without the need to reschedule a new cleaning task, thereby improving the cleaning efficiency and saving time.

In an implementation, when the cleaning device 101 is cleaning a bedroom and the user is suddenly notified of a friend's visit, it is necessary to prioritize the cleaning of the living room. The user may send a control instruction to the controller of the cleaning device 101 by means of the smart terminal 102 such that the order of the living room in the cleaning sequence is adjusted, to prioritize the cleaning of the living room. This can ensure that the cleaning of the living room is prioritized, without the need to reconfigure the cleaning task or wait for the current cleaning task to be completed, thereby enabling on-demand response to the user's needs.

In an implementation, when the user finds that a carpet in the living room is dirty, a control instruction may be sent to the controller of the cleaning device 101 by means of the smart terminal 102 such that the cleaning device performs focused cleaning on the carpet area during the execution of the cleaning task, such as cleaning the carpet area a plurality of times, to improve the cleaning effect.

In an implementation, when the user finds that an area in the living room has been cleaned, but the cleaning effect is not optimal, a control instruction may be sent to the controller of the cleaning device 101 by means of the smart terminal 102 such that the cleaning device returns to this for re-cleaning during the execution of the cleaning task, without the need to reschedule a new cleaning task. This can also improve the cleaning efficiency.

It should be noted that the specific scenarios of the unexpected situations that the cleaning device can cope with are not limited in the embodiments of the present application. The above is merely illustrative, and the method provided by the present application can flexibly cope with sudden changes in requirements during the cleaning task.

The smart terminal may also be referred to as user equipment (UE), a mobile station (MS), a mobile terminal, a terminal, a terminal device, etc. In practical applications, the smart terminal may include, for example: a desktop computer, a laptop computer, a personal digital assistant (PDA), a smartphone, a tablet computer, an in-vehicle device, a wearable device (such as a smart watch or a smart wristband), or a smart home device (such as a smart display device), etc. The types of the smart terminal are not specifically limited in the embodiments of the present application.

The type of the cleaning device may include, for example, a sweeping robot, an automatic floor scrubber, a robotic vacuum cleaner, etc. The type of the cleaning device is also not specifically limited in the embodiments of the present application.

It should be noted that the present application may be further applied to a mall scenario, a school scenario, or an office scenario. A specific application scenario is not limited in this embodiment of the present application. The above is merely illustrative.

The technical solutions of the present application and how the technical solutions of the present application solve the foregoing technical problem are described in detail below by using specific examples. The following specific embodiments may be combined with each other, and a same or similar concept or process may not be repeated in some embodiments. This embodiment of the present application is described below with reference to the drawings.

By way of example, FIG. 2 is a schematic flowchart of a cleaning device control method according to an embodiment of the present application. As shown in FIG. 2, the cleaning device control method is applied to a controller of a cleaning device, and includes the following steps.

In step S201, a first control instruction is received during execution of a current cleaning task. The first control instruction is an instruction for performing supplementary cleaning on a designated area within a work area which has been cleaned in the current cleaning task, the designated area is an area defined on a display interface of a smart terminal, and the smart terminal is communicatively connected to the cleaning device.

In the embodiments of the present application, the designated area may include an area previously obscured by an obstacle and then cleared by the user, and may further include an area with a missed spot, an area having a poor cleaning effect, etc. The specific scenarios of the designated area are not specifically limited in the embodiments of the present application.

By way of example, the cleaning device may clean an area to be cleaned according to a preset path or a cleaning strategy when executing a preset cleaning task. The specific content corresponding to the preset path or the cleaning strategy is not specifically limited in the embodiments of the present application. For example, the preset path is a zig-zag cleaning path.

Further, during the execution of the current cleaning task by the cleaning device, when the user finds an area previously obscured by an obstacle and then cleared by the user, the user may define a designated area, which requires supplementary cleaning, by means of the smart terminal, such as an application or a control interface on a smartphone, a tablet computer, etc.

Further, the application generates a first control instruction containing a designated area, and the smart terminal sends the first control instruction via wireless communication to the controller of the cleaning device. The controller receives the first control instruction from the smart terminal via wireless communication.

The user can circle a designated area on a cleaning map with his/her finger and mark the area as the designated area that requires supplementary cleaning. The method for the user to operate to determine the designated area on the smart terminal is not specifically limited in the embodiments of the present application. For example, the designated area may also be determined by other touch operations.

In step S202, the cleaning device is controlled, on the basis of the first control instruction, to travel to the designated area to perform supplementary cleaning on the designated area.

On the basis of the first control instruction, the cleaning device may be immediately controlled to travel to the designated area to perform supplementary cleaning on the designated area. It is also possible to control the cleaning device to travel to the designated area after the cleaning device completes the current cleaning task, to perform supplementary cleaning on the designated area. Alternatively, it is possible to control the cleaning device to travel to the designated area at any time, to perform supplementary cleaning on the designated area. For example, during the execution of the current cleaning task, after the cleaning of Area 1 is performed, if Area 2 is to be cleaned according to the original sequence, the cleaning device may be controlled to postpone cleaning of Area 2 and instead be controlled to travel to the designated area for supplementary cleaning. The timing of controlling the cleaning device to travel to the designated area is not specifically limited in the embodiments of the present application.

In an implementation, upon completion of the supplementary cleaning of the designated area, the cleaning device is controlled to continue to travel to a work area, which has not been cleaned during the current cleaning task, to perform cleaning.

By way of example, when the controller of the cleaning device receives the first control instruction from the smart terminal device, the cleaning device may parse the first control instruction to extract information of the designated area, then adjust its cleaning path to travel to the designated area to perform supplementary cleaning on the designated area to ensure that the area is thoroughly cleaned, and after the supplementary cleaning is performed on the designated area, continue to clean a work area that has not been cleaned in the current cleaning task.

In an implementation, the cleaning device may also be controlled to no longer perform any cleaning task after the supplementary cleaning of the designated area is completed, or the cleaning device may be controlled to travel a work area that has not been cleaned in the current cleaning task to perform cleaning after a certain period of time. The action performed by the cleaning device after the supplementary cleaning of the designated area is completed is not specifically limited in the embodiments of the present application.

In this way, a user can adjust the work area of the cleaning device in real time according to actual situations to flexibly cope with unexpected situations in family life. In particular, the user can detect and handle the area where supplementary cleaning needs to be performed in a timely manner. The designated area can be sufficiently cleaned through the supplementary cleaning, and the cleaning device can automatically continue the unfinished cleaning task upon the completion of the supplementary cleaning, ensuring the continuity and efficiency of the entire cleaning process, improving the cleaning efficiency. In the present application, the user can conveniently control the cleaning device by means of the smart terminal, to perform targeted cleaning on the designated area, thereby enhancing user satisfaction and user experience.

In an implementation, the designated area may include an area with a missed spot, an area obscured by an obstacle and then cleared by the user, etc. The area with a missed spot refers to an area which has been cleaned by the cleaning device but still contains a missed spot, such as a corner that has not been cleaned. The area obscured by an obstacle and then cleared by the user refers to an area previously obscured by an obscuration and then cleared by the user, such as an area exposed after the furniture has been removed. The specific scenarios of the area not covered by cleaning are not limited in the embodiments of the present application.

By way of example, when the controller of the cleaning device receives the first control instruction from the smart terminal, the controller may parse the first control instruction to extract information of the designated area obscured by an obstacle and then cleared by the user, then adjust the cleaning path of the cleaning device, return to the designated area, and execute a supplementary cleaning task in the designated area to ensure that the area is sufficiently cleaned.

In this way, the user can detect and handle the area with a missed spot and the area obscured by an obstacle and then cleared by the user in a timely manner. During the execution of the cleaning task by the cleaning device, the problem area is flexibly remedied through the supplementary cleaning task, so that the comprehensiveness and thoroughness of the entire cleaning task can be guaranteed, avoiding the omission of any areas and eliminating the need to reschedule the cleaning task.

In an implementation, the designated area is an area where the degree of soiling is greater than a preset threshold.

In the embodiments of the present application, an area where the degree of soiling is greater than a preset threshold indicates that the area is an area where the cleaning effect does not meet the user's needs, for example, stains or a significant amount of debris may still remain after cleaning. The setting of the preset threshold is an indicator for determining that a designated area still needs to be cleaned again, and the setting of the preset threshold is not specifically limited in the embodiments of the present application, and can be determined on the basis of the user's needs.

The area where the cleaning effect does not meet the user's needs refers to an area where the cleaning effect does not meet the user's desired cleaning effect or where the cleaning effect is poor or incomplete after being cleaned one or more times by the cleaning device, such as an area where there is still significant dust or stains. The specific scenarios of the area where the cleaning effect does not meet the user's needs are not limited in the embodiments of the present application.

In the present application, for the area where the degree of soiling is greater than a preset threshold, the smart terminal may generate a first control instruction for the area where re-cleaning is required.

By way of example, when the controller of the cleaning device receives the first control instruction from the smart terminal, the controller may parse the first control instruction, identify a designated area where re-cleaning is required, then adjust the cleaning path of the cleaning device, return to the designated area, and execute a re-cleaning task on the designated area, to ensure that the area achieves the cleaning effect expected by the user.

It should be noted that the cleaning strategy used by the cleaning device for re-cleaning the designated area may be the same as, or may be different from, the cleaning strategy used for the previous cleaning of the designated area. That is, the user can also specify, and send via the smart terminal, the strategy used for re-cleaning the designated area. The cleaning strategy used for re-cleaning is not specifically limited in the embodiments of the present application.

In this way, the user can adjust the work area of the cleaning device at any time according to actual situations to flexibly cope with unexpected situations in family life. In particular, the user can detect and handle the area where the degree of soiling is greater than the preset threshold in a timely manner. It is possible to ensure that all areas achieve the cleaning effect desired by the user through the re-cleaning operation, thereby improving the overall cleaning quality. In the present application, the user can conveniently control the cleaning device by means of the smart terminal, to ensure that the cleaning effect meets expectations, thereby enhancing user satisfaction and user experience.

In an implementation, the designated area is an area where the cleaning assembly of the cleaning device does not enter when in the second position; and controlling, on the basis of the first control instruction, the cleaning device to travel to the designated area to perform supplementary cleaning on the designated area includes:
controlling, on the basis of the first control instruction, the cleaning device to travel to the designated area, and controlling the cleaning assembly of the cleaning device to switch from the second position to the first position to perform supplementary cleaning on the designated area.

By way of example, when the cleaning device executes a cleaning task on an area in a preset cleaning mode, a mop assembly and/or a side brush assembly of the cleaning device is in the second position, such as in an extended position, that is, a significant portion of the mop assembly and/or the side brush assembly extends beyond the main body. In this case, if the area contains a narrow spot, such as an aisle, the aisle cannot be accessed for cleaning when the mop assembly and/or the side brush assembly is in the second position, resulting in an uncleaned spot left in the area. However, the user has found that the aisle can be accessed for cleaning when the mop assembly and/or the side brush assembly is in the first position, i.e. a retracted position.

Further, the user defines the aisle as a designated area by means of the smart terminal and generates a first control instruction for controlling the cleaning assembly of the cleaning device to switch from the second position to the first position by means of the smart terminal. Further, the first control instruction is sent to the controller of the cleaning device to control the cleaning device to travel to the designated area, and to control the cleaning assembly of the cleaning device to switch from the second position to the first position to perform supplementary cleaning on the designated area.

It should be noted that the type of the designated area corresponding to the switching of the cleaning assembly from the second position to the first position is not specifically limited in the embodiments of the present application. For example, the designated area may also be an area where the cleaning assembly of the cleaning device is prone to scraping against an obstacle when performing cleaning in the second position.

In this way, for an area where the cleaning assembly of the cleaning device cannot performing cleaning when in a previous working mode, it is determined, upon user confirmation, that changing the position of the cleaning assembly of the cleaning device allows access to this areas for cleaning, so that the user can adjust the working mode of the cleaning device at any time according to actual situations, thereby ensuring that no cleaning area is missed, and guaranteeing the comprehensiveness and thoroughness of the cleaning task, especially in complex environments.

In an implementation, performing supplementary cleaning on the designated area includes:
receiving a supplementary cleaning strategy sent by the smart terminal, or identifying cleaning requirements for the designated area and determining a supplementary cleaning strategy on the basis of the cleaning requirements; and
performing supplementary cleaning on the designated area on the basis of the supplementary cleaning strategy.

In the embodiments of the present application, the supplementary cleaning strategy is used to indicate a cleaning mode, a cleaning intensity, a cleaning path, etc. corresponding to the cleaning of the designated area. The cleaning mode includes deep cleaning, quick cleaning, carpet cleaning, dry cleaning, wet cleaning and other cleaning modes. The specific strategy corresponding to the supplementary cleaning strategy is not limited in the embodiments of the present application.

In an implementation, the user may select or set a supplementary cleaning strategy on the smart terminal such that the smart terminal sends the selected supplementary cleaning strategy to the controller of the cleaning device along with the first control instruction.

In an implementation, the cleaning requirements of an area that requires supplementary cleaning may be identified by means of at least one sensor, an artificial intelligence algorithm is used to identify the cleaning requirements, such as the material, the degree of soiling and the type of stain, of the area that requires supplementary cleaning, and the most suitable supplementary cleaning strategy is then automatically determined on the basis of the identified cleaning requirements.

Further, the controller of the cleaning device parses the first control instruction and the supplementary cleaning strategy, and adjusts the cleaning path and the cleaning mode of the cleaning device, to perform supplementary cleaning on the designated area.

In this way, the user can select or set up the supplementary cleaning strategy according to his/her need and preference, enabling a personalized cleaning scheme. Alternatively, by determining the supplementary cleaning strategy on the basis of the cleaning requirements, it is possible to ensure that the designated area is most suitable for cleaning treatment, improving the cleaning effect. Thus, the user can adjust the supplementary cleaning strategy flexibly, and the cleaning device can also automatically identify the cleaning requirements, to flexibly cope with different cleaning scenarios.

It should be noted that the operation indicated by the first control instruction can be one-shot, or the first control instruction may be stored, to automatically avoid the designated area according to the previously defined control logic upon subsequent encounter of the designated area. The control logic includes control over the travel path and/or the cleaning strategy of the cleaning device. The corresponding content of the control logic is not specifically limited in the embodiments of the present application.

In an implementation, the first control instruction is a one-shot control instruction.

By way of example, the smart terminal generates a first control instruction on the basis of a touch operation of the user. In addition to containing information about the designated area, the first control instruction is also marked as one-shot, and is thus only valid during the current cleaning task.

Further, upon receiving the first control instruction from the smart terminal, the controller of the cleaning device controls the cleaning device to complete the supplementary cleaning of the designated area, the first control instruction then will become invalid, that is, at the start of the next cleaning task, the cleaning device will no longer automatically travel to the previous designated area for supplementary cleaning, unless the user sends a new first control instruction.

In this way, the one-shot control instruction avoids the complexity of the persistent setting, eliminating user concerns about long-term impacts on the working path of the cleaning device, so that the user only has to send the first control instruction when necessary, thereby enabling simple operation and enabling on-demand control over the cleaning device to perform supplementary cleaning on the designated area at any time.

In an implementation, the method further includes: storing the first control instruction, so as to directly invoke the first control instruction the next time the designated area is encountered.

In an embodiment of that application, the cleaning device or the smart terminal may store the first control instruction. The storage location may be an internal memory of the cleaning device, a storage space of the smart terminal, or cloud storage, and will not be specifically limited in the embodiments of the present application.

The stored information may include coordinates or location data of the designated area, and related metadata of the instruction, such as generation time and user annotation information. The stored information is not specifically limited in the embodiments of the present application.

By way of example, at the start of the next cleaning task, the user may choose to directly invoke the previously stored first control instruction to avoid repetitive operations, or may open a control application on the smart terminal to select a previously stored instruction for the designated area without the need to perform any touch operations.

In an implementation, the user may update or delete the stored first control instruction as needed to flexibly cope with changes in family life.

In this way, there is no need for the user to manually set the designated area to undergo supplementary cleaning each time, saving time and effort and improving operational efficiency. The user can also conveniently invoke the previously stored instruction, thereby enabling simple operation, and the stored control instruction can be quickly invoked, thereby simplifying the operational steps of the user, and enhancing user experience and satisfaction.

In an implementation, the defined area is determined by a touch operation of a user on the display interface of the smart terminal, the touch operation including any one of the following: a frame selection operation, a single tap operation, a double tap operation, a long press operation, a swipe operation, a drag and drop operation, and a multi-finger operation.

The frame selection operation may involve the user pressing and holding a point on the display interface, then dragging his/her finger to form a rectangular frame, with the area within the rectangular frame being the designated area selected by the user. The rectangular frame may also be replaced by frames of other shapes, which will not be specifically limited in the embodiments of the present application.

The single tap operation may involve the user tapping a point on the display interface. The smart terminal then treats the tapped point as the center of the designated area and generates a circular or square area of a default size, and this area is the designated area selected by the user.

The double tap operation may involve the user quickly double-tapping a point on the display interface. The smart terminal then treats the double-tapped point as the center of the designated area and generates a relatively large or predefined-sized circular or square area, and this area is the designated area selected by the user.

The long press operation may involve the user pressing and holding a point on the display interface until a selection menu or a marker of the designated area appears. The smart terminal then treats the long-pressed point as the center of the designated area and generates an area whose size can be adjusted by the user, and this area is the designated area selected by the user.

The swipe operation may involve the user swiping his/her finger across the display interface to form a path, and the smart terminal marks an area within a certain range on either side of the swipe path as the designated area.

The drag and drop operation may involve the user pressing and holding a point on the display interface, then dragging his/her finger to another point to form a rectangular or other shaped area. The smart terminal then marks the area between the starting and ending points as the designated area.

The multi-finger operation may involve the user performing actions on the display interface using two or more fingers, such as zooming in, zooming out, or rotating. The smart terminal then generates an area with a specific shape and size based on the multi-finger operation, and this area is the designated area selected by the user.

It should be noted that the implementations of the various touch operations described above for determining the designated area are not specifically limited in the embodiments of the present application. The above is merely illustrative, and the designated area may also be determined through other implementations, which will not be described in detail herein.

Therefore, in the embodiments of the present application, by performing the various touch operations described above on the display interface, the user can flexibly and conveniently determine the designated area requiring supplementary cleaning.

In an implementation, the display interface includes at least a cleaning map; the cleaning map includes a plurality of cleaning areas; and each cleaning area is capable of displaying a cleaning status for a user to view.

In the embodiments of the present application, the cleaning map may illustrate the layout of various areas, including a plurality of cleaning areas, such as a living room, a bedroom, and a kitchen. Each cleaning area may display its current cleaning status, such as cleaned, uncleaned and in progress, on the cleaning map, so that the user can view the status of each cleaning area through the display interface, understand the progress of the cleaning task, and determine the cleaning effect of the area after cleaning.

In this way, the user can monitor the progress of the cleaning task in real time through the display interface, understand the cleaning status of each area, and adjust the work area of the cleaning device at any time according to actual situations, to flexibly cope with unexpected situations in family life. The display interface is intuitive and user-friendly, enabling the user to operate it conveniently, thereby enhancing user experience and satisfaction.

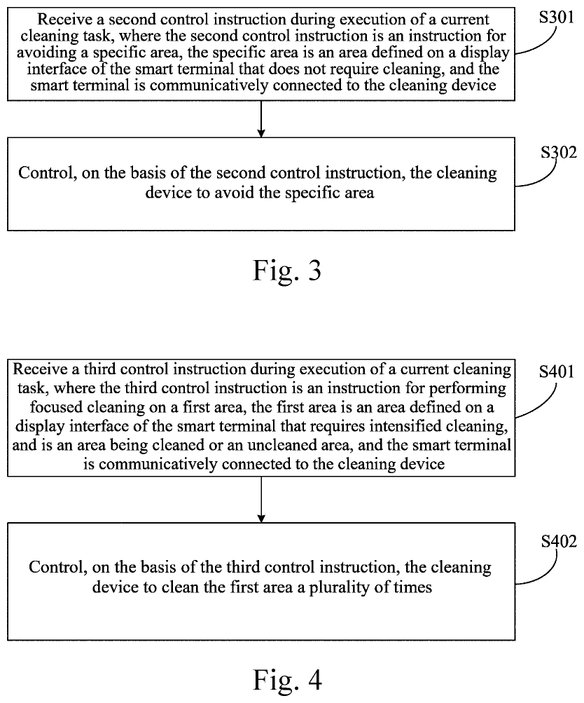

By way of example, FIG. 3 is a schematic flowchart of another cleaning device control method according to an embodiment of the present application. As shown in FIG. 3, the cleaning device control method is applied to a controller of a cleaning device, and includes the following steps.

In step S301, a second control instruction is received during execution of a current cleaning task. The second control instruction is an instruction for avoiding a specific area, the specific area is an area defined on a display interface of the smart terminal that does not require cleaning, and the smart terminal is communicatively connected to the cleaning device.

In the embodiments of the present application, an area that do not require cleaning refers to an area determined by the user where the cleaning device is not required to access to perform cleaning, such as an area that has been cleaned, an area where a valuable or fragile item is placed, or an occupied area. The occupied area refer to an area occupied by the user or by other people or pets observed by the user, such as an area where children are playing, or an area where the user is exercising. The specific scenarios of the specific area are not limited in the embodiments of the present application.

By way of example, during the execution of the current cleaning task by the cleaning device, when the user finds that an area does not require cleaning or is occupied, for example, when someone is active in the living room area, the user can determine that the living room area needs to be avoided by means of an application or a control interface on the smart terminal, such as a smartphone or a tablet computer.

Further, the application generates a second control instruction containing a living room area, and the smart terminal sends the second control instruction via wireless communication to the controller of the cleaning device. The controller of the cleaning device receives the second control instruction from the smart terminal via wireless communication.

The user can circle a living room area on a cleaning map with his/her finger and mark the area as the specific area that needs to be avoided. The method for the user to operate to determine the specific area on the smart terminal is not specifically limited in the embodiments of the present application. For example, the specific area may also be determined by other touch operations.

In step S302, the cleaning device is controlled, on the basis of the second control instruction, to avoid the specific area.

By way of example, when the controller of the cleaning device receives the second control instruction from the smart terminal, the controller may parse the second control instruction, and identify the living room area that needs to be avoided. The controller then controls the cleaning device to avoid the specific area.

In an implementation, when the cleaning device avoids the specific area, the cleaning task of the remaining areas may also continue to be executed, ensuring the cleaning efficiency and effect, or the cleaning task may no longer be executed. This is not specifically limited in the embodiments of the present application.

Therefore, the user can adjust the work area of the cleaning device in real time according to actual situations to flexibly cope with unexpected situations in family life, enhancing the intelligence and adaptability of the cleaning device. In particular, the user can conveniently control the cleaning device to avoid the specific area by means of the smart terminal, thereby enabling simple operation, and enhancing user experience and satisfaction. In the present application, the cleaning device may, in response to the control instruction generated by the smart terminal, avoid an occupied area during execution of the cleaning task by the cleaning device, preventing the cleaning device from entering the occupied area, reducing interference to people and pets, avoiding potential collision and injury risks, avoiding areas that do not require cleaning, reducing the operating time and energy consumption of the cleaning device, and prolonging battery life and the overall service life of the cleaning device.

In an implementation, the second control instruction is a one-shot control instruction.

By way of example, the smart terminal may generate a second control instruction on the basis of a touch operation of the user. In addition to containing information about the specific area, the second control instruction may also be marked as one-shot, and is thus only valid during the current cleaning task.

Further, upon receiving the second control instruction from the smart terminal, the controller of the cleaning device controls the cleaning device to avoid the specific area, and after the cleaning device completes the current cleaning task, the second control instruction will become invalid, that is, at the start of the next cleaning task, the cleaning device will no longer avoid the specific area previously specified, unless the user sends a new second control instruction.

In this way, the one-shot control instruction avoids the complexity of the persistent setting, eliminating user concerns about long-term impacts on the working path of the cleaning device, so that the user only has to send the second control instruction when necessary, thereby enabling simple operation and enabling on-demand control for controlling the cleaning device to avoid the specific area at any time.

In an implementation, the method further includes: storing the second control instruction, so as to directly invoke the second control instruction the next time the specific area is encountered.

It will be appreciated that the storage and use of the second control instruction are similar to those of the first control instruction, details of which may refer to the description of the first control instruction and will not be described in detail herein.

In this way, there is no need for the user to manually set the area to be avoided each time, saving time and effort and improving operational efficiency. The user can also conveniently invoke the previously stored instruction, thereby enabling simple operation, and the stored control instruction can be quickly invoked, thereby simplifying the operational steps of the user, and enhancing user experience and satisfaction.

In an implementation, the defined area is determined by a touch operation of a user on the display interface of the smart terminal, the touch operation including any one of the following: a frame selection operation, a single tap operation, a double tap operation, a long press operation, a swipe operation, a drag and drop operation, and a multi-finger operation.

It should be noted that the implementation and effect of the touch operation corresponding to the generation of the second control instruction are similar to the implementation and effect of the touch operation corresponding to the generation of the first control instruction, details of which may refer to the description of the above embodiments and will not be described in detail herein.

In an implementation, the display interface includes at least a cleaning map; the cleaning map includes a plurality of cleaning areas; and each cleaning area is capable of displaying a cleaning status for a user to view.

It should be noted that the definition and effect of the cleaning map required for generating the second control instruction are similar to the definition and effect of the cleaning map required for generating the first control instruction, details of which may refer to the description of the above embodiments and will not be described in detail herein.

By way of example, FIG. 4 is a schematic flowchart of still another cleaning device control method according to an embodiment of the present application. As shown in FIG. 4, the cleaning device control method is applied to a controller of a cleaning device, and includes the following steps.

In step S401, a third control instruction is received during execution of a current cleaning task. The third control instruction is an instruction for performing focused cleaning on a first area, the first area is an area defined on a display interface of the smart terminal that requires intensified cleaning, and is an area being cleaned or an uncleaned area, and the smart terminal is communicatively connected to the cleaning device.

The uncleaned area includes an uncleaned area corresponding to the current cleaning task and an uncleaned area not corresponding to the current cleaning task.

In the embodiments of the present application, the area that requires intensified cleaning refers to an area where focused cleaning is required to meet the requirements of cleanliness, such as an area with stubborn stains, a pet activity area, or a high-traffic area. The specific scenarios of the area that requires intensified cleaning are not limited in the embodiments of the present application.

It should be noted that the implementation of S401 is similar to that of S201, details of which may refer to the description of S201, except that S401 is used for determining the first area, and the smart terminal generates a third control instruction accordingly.

In step S402, the cleaning device is controlled, on the basis of the third control instruction, to clean the first area a plurality of times.

It should be noted that the implementation of S402 is similar to that of S202, details of which may refer to the description of S202, except that S202 is used for controlling the cleaning device to perform supplementary cleaning, whereas S402 is used for controlling the cleaning device to perform multiple cleanings.

It should be noted that the cleaning strategy used by the cleaning device for cleaning the first area a plurality of times may be the same as, or may be different from, the cleaning strategies used for the other areas. That is, the user can also specify, and send via the smart terminal, the strategy used for cleaning the first area a plurality of times. The strategy used for multiple cleanings may also correspond to multiple types of cleaning strategies. The cleaning strategy used for multiple cleanings is not specifically limited in the embodiments of the present application.

In an implementation, the cleaning device may also be controlled to no longer perform any cleaning task after the multiple cleanings of the first area are completed, or the cleaning device may be controlled to continue to execute the current cleaning task after a certain period of time. The action performed by the cleaning device after the multiple cleanings of the first area are completed is not specifically limited in the embodiments of the present application.

In this way, the user can adjust the work area of the cleaning device at any time according to actual situations to flexibly cope with unexpected situations in family life. In particular, the user can perform focused cleaning on stubborn stains or high-traffic areas. It is possible to ensure that the focused area is thoroughly cleaned through multiple cleaning operations, thereby improving the overall cleaning quality. In the present application, the user can conveniently control the cleaning device by means of the smart terminal, to ensure that the cleaning effect meets expectations, thereby enhancing user satisfaction and user experience.

In an implementation, the third control instruction is a one-shot control instruction.

It should be noted that the third control instruction is similar to the first control instruction in terms of the implementation principle of the one-shot control instruction, details of which may refer to the description of the above embodiments and will not be described in detail herein.

In this way, by using the one-shot third control instruction, the user can flexibly and conveniently control the cleaning device to clean the first area a plurality of times, ensuring efficient, safe and personalized execution of the cleaning task. Moreover, the one-shot control instruction avoids the complexity of the persistent setting, eliminating user concerns about long-term impacts on the working path of the cleaning device, and the one-shot control instruction ensures that the cleaning device only performs re-cleaning in the current task, saving time and resources.

In an implementation, the method further includes: storing the third control instruction, so as to directly invoke the third control instruction the next time the first area is encountered.

It will be appreciated that the storage and use of the third control instruction are similar to those of the first control instruction, details of which may refer to the description of the first control instruction and will not be described in detail herein.

In this way, there is no need for the user to manually set the first area to undergo multiple cleanings each time, saving time and effort and improving operational efficiency. The user can also conveniently invoke the previously stored instruction, thereby enabling simple operation, and the stored control instruction can be quickly invoked, thereby simplifying the operational steps of the user, and enhancing user experience and satisfaction.

In an implementation, during the execution of the current cleaning task, the cleaning assembly of the cleaning device is in the second position. Controlling, on the basis of the third control instruction, the cleaning device to clean the first area a plurality of times includes:
controlling, on the basis of the third control instruction, the cleaning device to travel to the first area, and controlling the cleaning assembly of the cleaning device to switch from the second position to the first position to perform supplementary cleaning on the first area.

In the present application, the cleaning assembly of the cleaning device is in the second position during the execution of the current cleaning task by the cleaning device. However, when there is a need for the user to clean the first area a plurality of times, the user has found that if the cleaning assembly of the cleaning device is in the second position to clean the first area, it may be unable to access the first area or may easily scrape against an obstacle within the first area. In this case, the user defines the first area by means of the smart terminal and generates a third control instruction by means of the smart terminal to control the cleaning assembly of the cleaning device to switch from the second position to the first position. Further, the third control instruction is sent to the controller of the cleaning device to control the cleaning device to travel to the first area, and to control the cleaning assembly of the cleaning device to switch from the second position to the first position to clean the first area a plurality of times.

In this way, the user can flexibly define the area requiring multiple cleanings by means of the smart terminal according to actual requirements and control the position of the cleaning assembly of the cleaning device, such that the cleaning device can better adapt to different cleaning tasks and environments. Moreover, by switching the position of the cleaning assembly, it is possible to avoid scratching the cleaning device against an obstacle when access to the specific area, thereby reducing damage to the device and furniture, and improving the safety of the cleaning process.

In an implementation, the defined area is determined by a touch operation of a user on the display interface of the smart terminal, the touch operation including any one of the following: a frame selection operation, a single tap operation, a double tap operation, a long press operation, a swipe operation, a drag and drop operation, and a multi-finger operation.

It should be noted that the implementation and effect of the touch operation corresponding to the generation of the third control instruction are similar to the implementation and effect of the touch operation corresponding to the generation of the first control instruction, details of which may refer to the description of the above embodiments and will not be described in detail herein.

In an implementation, the display interface includes at least a cleaning map; the cleaning map includes a plurality of cleaning areas; and each cleaning area is capable of displaying a cleaning status for a user to view.

It should be noted that the definition and effect of the cleaning map required for generating the third control instruction are similar to the definition and effect of the cleaning map required for generating the first control instruction, details of which may refer to the description of the above embodiments and will not be described in detail herein.

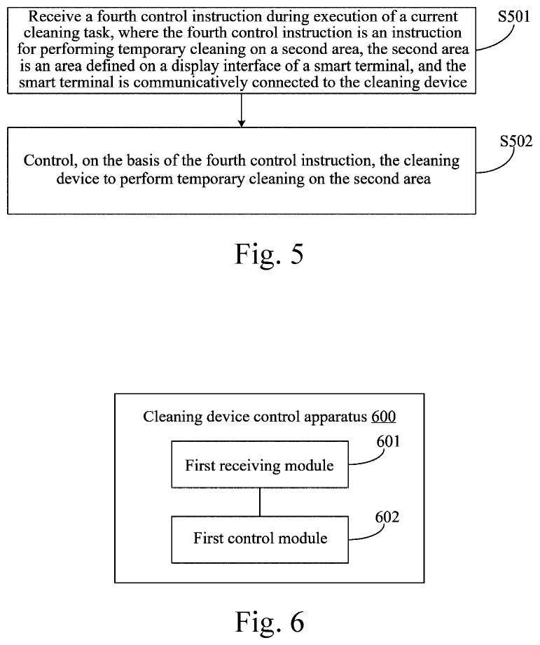

By way of example, FIG. 5 is a schematic flowchart of yet another cleaning device control method according to an embodiment of the present application. As shown in FIG. 5, the cleaning device control method is applied to a controller of a cleaning device, and includes the following steps.

In step S501, a fourth control instruction is received during execution of a current cleaning task. The fourth control instruction is an instruction for performing temporary cleaning on a second area, the second area is an area defined on a display interface of a smart terminal, and the smart terminal is communicatively connected to the cleaning device.

In step S502, the cleaning device is controlled, on the basis of the fourth control instruction, to perform temporary cleaning on the second area.

In the embodiments of the present application, controlling the cleaning device to perform temporary cleaning on the second area is determined on the basis of the user's temporary need. This temporary need allows the cleaning device to respond more flexibly to the user's instant need. In this way, upon receiving the fourth control instruction, the controller of the cleaning device controls the cleaning device to immediately travel to the second area for cleaning without waiting for the completion of a previous cleaning task and without affecting the progress of the entire cleaning task. After the cleaning of the second area is completed, the cleaning device can continue to clean on the basis of the previous cleaning task.

It should be noted that in the present application, only the order of the second area in the cleaning sequence is determined, that is, the second area is set to the highest priority in the cleaning sequence. In the present application, no specific adjustment is made to the cleaning sequence determined before the cleaning device executes the cleaning task. This cleaning sequence may continue to be used or may be adjusted adaptively after the cleaning of the second area is completed.

By way of example, the cleaning sequence determined before the cleaning device executes the cleaning task is Area 1-Area 2-Area 3, and the fourth control instruction indicates that the second area is Area 2, that is, Area 2 needs priority treatment. In this case, the cleaning device is controlled, on the basis of the fourth control instruction, to adjust the order of the second area in the cleaning sequence. The cleaning sequence may be Area 2-Area 1-Area 3, or may be Area 2-Area 1-Area 2-Area 3. The fourth control instruction controls only the second area to have the highest priority and undergo cleaning first, while the individual orders of the other areas in the cleaning sequence afterward are not limited.

It should be noted that the implementation of S501 is similar to that of S201, details of which may refer to the description of S501, except that S501 is used for determining the second area, and the smart terminal generates a fourth control instruction accordingly. The fourth control instruction is configured to control the cleaning device to adjust the order of the second area in the cleaning sequence.

By way of example, when the controller of the cleaning device receives the fourth control instruction from the smart terminal, the controller may parse the fourth control instruction, identify the adjusted cleaning sequence, and then control the cleaning device to clean the second area in accordance with the adjusted cleaning sequence, ensuring that the temporary needs of the user are met.

Therefore, the user can temporarily adjust the cleaning sequence according to actual situations to flexibly cope with unexpected situations in family life. It is possible to ensure timely cleaning of a focused area by prioritizing the cleaning of the second area, thereby improving the overall cleaning efficiency. Moreover, the temporal adjustment of the order of the second area in the cleaning sequence can prevent the cleaning device from cleaning the specific area at an inappropriate time, thereby improving the safety and comfort of family members. In the present application, the user can conveniently control the cleaning device by means of the smart terminal, to ensure that the cleaning effect meets expectations, thereby enhancing user satisfaction and user experience.

In an implementation, the fourth control instruction is a one-shot control instruction.

It should be noted that the fourth control instruction is similar to the first control instruction in terms of the implementation principle of the one-shot control instruction, details of which may refer to the description of the above embodiments and will not be described in detail herein.

In this way, by using the one-shot fourth control instruction, the user can flexibly and conveniently control the cleaning device to adjust the order of the second area in the cleaning sequence, ensuring efficient, safe and personalized execution of the cleaning task. Moreover, the one-shot control instruction avoids the complexity of the persistent setting, eliminating user concerns about long-term impacts on the working path of the cleaning device, and the one-shot control instruction ensures that the cleaning device only performs re-cleaning in the current task, saving time and resources.

In an implementation, the method further includes: storing the fourth control instruction, so as to directly invoke the fourth control instruction the next time the second area is encountered.

It will be appreciated that the storage and use of the fourth control instruction are similar to those of the first control instruction, details of which may refer to the description of the first control instruction and will not be described in detail herein.

In this way, there is no need for the user to manually set the order of the second area in the cleaning sequence each time, saving time and effort and improving operational efficiency. The user can also conveniently invoke the previously stored instruction, thereby enabling simple operation, and the stored control instruction can be quickly invoked, thereby simplifying the operational steps of the user, and enhancing user experience and satisfaction.

In an implementation, controlling, on the basis of the fourth control instruction, the cleaning device to adjust the order of the second area in the cleaning sequence to perform temporary cleaning on the second area includes:
determining a third area corresponding to the execution of the current cleaning task, the third area including at least an uncleaned area;
determining the second area for temporary cleaning on the basis of the fourth control instruction; and
adjusting a cleaning sequence to prioritize the second area over the third area, so as to perform temporary cleaning on the second area.

In some embodiments, the cleaning sequence for all areas before executing the cleaning task is determined to be Area 1-Area 2-Area 3. If the third area corresponding to the execution of the current cleaning task is determined to be Area 1, and the second area undergoing temporary cleaning is determined to be Area 2 on the basis of the fourth control instruction, the order of Area 2 in the cleaning sequence is then adjusted to come before the order of Area 1 in the cleaning sequence, and a new cleaning sequence of Area 2-Area 1-Area 3 is generated.

Area 1 may be partially cleaned and partially uncleaned. In this case, the generated new cleaning sequence may be Area 2-uncleaned part of Area 1-Area 3, or Area 2-Area 1 (the entire cleaning area)-Area 3, which is not specifically limited in the embodiments of the present application. When cleaning the uncleaned part of Area 1, the cleaning device may return to the corresponding point at which the cleaning of Area 1 was stopped, and continue cleaning along the previous cleaning path from that point. In this way, the previously cleaned area does not need to be cleaned again, saving cleaning time and improving the cleaning efficiency.

In some other embodiments, the cleaning sequence for all areas before executing the cleaning task is determined to be Area 1-Area 2-Area 3. If the third area corresponding to the execution of the current cleaning task is determined to be Area 1, and the second area undergoing temporary cleaning is determined to be Area 4 on the basis of the fourth control instruction, the order of Area 4 in the cleaning sequence is then adjusted to come before the order of Area 1 in the cleaning sequence, creating a new cleaning sequence of Area 4-Area 1-Area 2-Area 3.

Accordingly, the cleaning process for Area 1 is similar to the above embodiment and will not be described in detail herein.

Therefore, in the embodiments of the present application, by adjusting the order of the second area in the cleaning sequence, it is possible to ensure that a critical area is cleaned in a timely and prioritized manner. In an implementation, after the second area has been first cleaned, the cleaning device can still proceed to clean the third area, ensuring that all uncleaned areas are cleaned.

In an implementation, performing temporary cleaning on the second area includes:
receiving a cleaning strategy sent by the smart terminal, and performing temporary cleaning on the second area on the basis of the cleaning strategy, the cleaning strategy being determined on the basis of temporary requirements from a user.

In the embodiments of the present application, the fourth control instruction contains information of the adjusted order of the second area in the cleaning sequence and the cleaning strategy of the second area. The cleaning strategy may be any cleaning mode, cleaning intensity, cleaning path, etc. specified by the user, which will not be specifically limited in the embodiments of the present application.

In this way, the user specifies the cleaning strategy for the second area, such that a personalized, targeted and efficient cleaning of the second area can be achieved, ensuring that the cleaning task meets current requirements.

In an implementation, the defined area is determined by a touch operation of a user on the display interface of the smart terminal, the touch operation including any one of the following: a frame selection operation, a single tap operation, a double tap operation, a long press operation, a swipe operation, a drag and drop operation, and a multi-finger operation.

The drag and drop operation may involve the user long-pressing a cleaning area and then dragging it to a new position to reorder the sequence. For example, the user may long-press a cleaning area and drag it to the top of the list to raise its priority.

The swipe operation may involve the user swiping his/her finger on a cleaning area to reveal more options, such as marking it as high priority. The user may swipe a cleaning area to the right to mark it as high priority.

The single tap operation may involve the user tapping a cleaning area to select it, and then using an on-screen button or menu option to change its priority. For example, the user may tap a cleaning area and then select a “Mark as High Priority” button.

The double tap operation may involve the user quickly double-tapping a cleaning area to mark it as high priority directly or make other priority adjustments. For example, the user may double-tap a cleaning area to mark it as high priority.

The long press operation may involve the user long-pressing a cleaning area to reveal a context menu and then selecting a priority adjustment option. For example, the user may long-press a cleaning area and then choose a “Priority Sorting” option.

The frame selection operation may involve the user selecting a plurality of cleaning areas by using a multi-selection gesture, such as long-pressing and dragging, or using check boxes, and then batch-adjusting their priorities.

The multi-finger operation may involve the user operating on the screen with two or more fingers simultaneously, selecting a plurality of cleaning areas and adjusting their sequence in one action.

It should be noted that the implementations of the various touch operations described above for adjusting the cleaning sequence for the cleaning areas are not specifically limited in the embodiments of the present application. The above is merely illustrative, and the cleaning sequence may also be adjusted through other implementations, which will not be described in detail herein.

Therefore, in the embodiments of the present application, by performing the various touch operations described above on the display interface, the user can flexibly and conveniently determine the second area for temporary cleaning and adjust the order of the second area in the cleaning sequence.

In an implementation, the display interface includes at least a cleaning map; the cleaning map includes a plurality of cleaning areas; and each cleaning area is capable of displaying a cleaning status for a user to view.

It should be noted that the definition and effect of the cleaning map required for generating the fourth control instruction are similar to the definition and effect of the cleaning map required for generating the first control instruction, details of which may refer to the description of the above embodiments and will not be described in detail herein.

It should be noted that the display interface may be accessed by setting a “Smart Cleaning Mode” button on the application interface of the smart terminal. After tapping the button, the user can enter the visual page to perform various operations.

After each operation, the application may also feed back information to the user via a pop-up or tone to confirm that the operation has been successful, and update the task status in real time in a task progress bar, such as “Living room set to priority cleaning” or “Kitchen corner supplementary cleaning in progress.”

In the foregoing embodiments, the cleaning device control method provided in the embodiments of the present application is described. In order to achieve the foregoing functions in the method provided in the embodiments of the present application, an electronic device which is an execution body may include a hardware structure and/or a software module. The foregoing functions may be implemented in a form of a hardware structure, a software module, or a combination of a hardware structure and a software module. Whether one of the foregoing functions is implemented in the form of a hardware structure, a software module, or a combination of a hardware structure and a software module depends on specific application and design constraints of the technical solutions.

By way of example, FIG. 6 is a structural schematic diagram of a cleaning device control apparatus according to an embodiment of the present application. As shown in FIG. 6, the cleaning device control apparatus 600 is applied to a controller of a cleaning device. The apparatus 600 includes:
a first receiving module 601 configured to receive a first control instruction during execution of a current cleaning task, where the first control instruction is an instruction for performing supplementary cleaning on a designated area within a work area which has been cleaned in the current cleaning task, the designated area is an area defined on a display interface of a smart terminal, and the smart terminal is communicatively connected to the cleaning device; and
a first control module 602 configured to control, on the basis of the first control instruction, the cleaning device to travel to the designated area to perform supplementary cleaning on the designated area; and to control, upon completion of the supplementary cleaning of the designated area, the cleaning device to continue to travel to a work area, which has not been cleaned during the current cleaning task, to perform cleaning.

In an implementation, the designated area is an area not covered by cleaning.

In an implementation, the designated area is an area where the degree of soiling is greater than a preset threshold.

In an implementation, the cleaning device includes a cleaning assembly and a main body; the cleaning assembly has a first position and a second position; a part of the cleaning assembly that is located outside a peripheral side of the main body when in the second position is larger than a part of the cleaning assembly that is located outside the peripheral side of the main body when in the first position; the designated area is an area where the cleaning assembly of the cleaning device does not enter when in the second position; and the first control module 602 is in particular configured to
control, on the basis of the first control instruction, the cleaning device to travel to the designated area, and to control the cleaning assembly of the cleaning device to switch from the second position to the first position to perform supplementary cleaning on the designated area.

In an implementation, the first control module 602 is particularly configured to:
receive a supplementary cleaning strategy sent by the smart terminal, or to identify cleaning requirements for the designated area and determining a supplementary cleaning strategy on the basis of the cleaning requirements; and
perform supplementary cleaning on the designated area on the basis of the supplementary cleaning strategy.

In an implementation, the first control instruction is a one-shot control instruction.

In an implementation, the apparatus 600 further includes a first storage module configured to store the first control instruction, so as to directly invoke the first control instruction the next time the designated area is encountered.

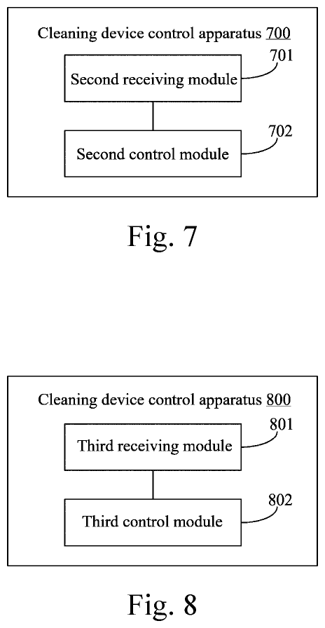

By way of example, FIG. 7 is a structural schematic diagram of another cleaning device control apparatus according to an embodiment of the present application. As shown in FIG. 7, the cleaning device control apparatus 700 is applied to a controller of a cleaning device. The apparatus 700 includes:
a second receiving module 701 configured to receive a second control instruction during execution of a current cleaning task, where the second control instruction is an instruction for avoiding a specific area, the specific area is an area defined on a display interface of the smart terminal that does not require cleaning, and the smart terminal is communicatively connected to the cleaning device; and
a second control module 702 configured to control, on the basis of the second control instruction, the cleaning device to avoid the specific area.

In an implementation, the second control instruction is a one-shot control instruction. The second control instruction is configured to control the cleaning device to perform supplementary cleaning on a supplementary cleaning area during the execution of the current cleaning task.

In an implementation, the apparatus further includes a second storage module configured to store the second control instruction, so as to directly invoke the second control instruction the next time it is necessary to perform supplementary cleaning on the supplementary cleaning area.

In an implementation, the second control instruction is a one-shot control instruction.

In an implementation, the apparatus 700 further includes a second storage module configured to store the second control instruction, so as to directly invoke the second control instruction the next time the specific area is encountered.

By way of example, FIG. 8 is a structural schematic diagram of still another cleaning device control apparatus according to an embodiment of the present application. As shown in FIG. 8, the cleaning device control apparatus 800 is applied to a controller of a cleaning device. The apparatus 800 includes:
a third receiving module 801 configured to receive a third control instruction during execution of a current cleaning task, where the third control instruction is an instruction for performing focused cleaning on a first area, the first area is an area defined on a display interface of the smart terminal that requires intensified cleaning, and is an area being cleaned or an uncleaned area, and the smart terminal is communicatively connected to the cleaning device; and
a third control module 802 configured to control, on the basis of the third control instruction, the cleaning device to clean the first area a plurality of times.

In an implementation, the third control instruction is a one-shot control instruction.

In an implementation, the apparatus 800 further includes a third storage module configured to store the third control instruction, so as to directly invoke the third control instruction the next time the first area is encountered.

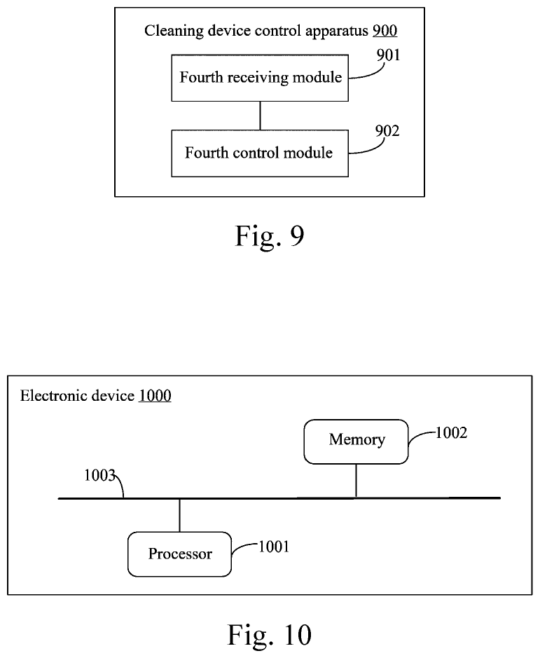

By way of example, FIG. 9 is a structural schematic diagram of yet another cleaning device control apparatus according to an embodiment of the present application. As shown in FIG. 9, the cleaning device control apparatus 900 is applied to a controller of a cleaning device. The apparatus 900 includes:
a fourth receiving module 901 configured to receive a fourth control instruction during execution of a current cleaning task, where the fourth control instruction is an instruction for performing temporary cleaning on a second area, the second area is an area defined on a display interface of a smart terminal, and the smart terminal is communicatively connected to the cleaning device; and
a fourth control module 902 configured to control, on the basis of the fourth control instruction, the cleaning device to adjust the order of the second area in the cleaning sequence to perform temporary cleaning on the second area.

In an implementation, the fourth control instruction is a one-shot control instruction.

In an implementation, the apparatus 900 further includes a fourth storage module configured to store the fourth control instruction, so as to directly invoke the fourth control instruction the next time the second area is encountered.

In an implementation, the fourth control module 902 is particularly configured to:
determine a third area corresponding to the execution of the current cleaning task, the third area including at least an uncleaned area;
determine the second area for temporary cleaning on the basis of the fourth control instruction; and
adjust a cleaning sequence to prioritize the second area over the third area, so as to perform temporary cleaning on the second area.

In an implementation, the fourth control module 902 is particularly configured to:
receive a cleaning strategy sent by the smart terminal, and perform temporary cleaning on the second area on the basis of the cleaning strategy, the cleaning strategy being determined on the basis of temporary requirements from a user.

In an implementation, the defined area is determined by a touch operation of a user on the display interface of the smart terminal, the touch operation including any one of the following: a frame selection operation, a single tap operation, a double tap operation, a long press operation, a swipe operation, a drag and drop operation, and a multi-finger operation.

In an implementation, the display interface includes at least a cleaning map; the cleaning map includes a plurality of cleaning areas; and each cleaning area is capable of displaying a cleaning status for a user to view.

It should be noted that the specific implementation principles and effects of the cleaning device control apparatuses corresponding to FIGS. 6-9 described above may refer to the corresponding relevant descriptions and effects of the above embodiments, and will not be described in detail herein.

By way of example, an embodiment of the present application also provides a cleaning device control system, including: a cleaning device and a smart terminal, where the cleaning device includes a controller;
the smart terminal is communicatively connected to the cleaning device; and the smart terminal is configured to send a control instruction to the controller.

The controller is configured to perform the method described in any of the above embodiments.

The control instruction includes a first control instruction, a second control instruction, a third control instruction, and a fourth control instruction. Accordingly, the corresponding action performed by the cleaning device controlled on the basis of the control instruction includes: controlling the cleaning device to avoid a specific area, controlling the cleaning device to travel to a designated area to perform supplementary cleaning on the designated area, controlling the cleaning device to perform clean a first area a plurality of times, and controlling the cleaning device to perform temporary cleaning on a second area.

Therefore, with such a cleaning device control system, the user can conveniently generate a control instruction by operating the smart terminal, to flexibly adjust the cleaning schedule and strategy of the cleaning device during the execution of the cleaning task, thereby not only enhancing the operational convenience and flexibility but also ensuring that the user can flexibly adjust the cleaning schedule of the cleaning device according to actual requirements and preferences, thereby ensuring that the cleaning task meets current requirements.

In an implementation, the control instruction is determined from a type of area selected by a user on a display interface of the smart terminal.

In the embodiments of the present application, the type of area includes a designated area, a specific area, a first area, and a second area. The selection of the type of area refers to the determination of which control instruction is generated in response to a user's selection operation on the display interface of the smart terminal.

In some embodiments, in response to the user tapping or frame-selecting a cleaning area on the display interface of the smart terminal, such as in the cleaning map, a plurality of icon options are popped up in the upper right corner or an adjacent area of the cleaning area. The plurality of icon options are configured to instruct the user to select which area to perform the corresponding action. For example, there are four icons: the first icon indicates selecting a designated area for supplementary cleaning, the second icon indicates selecting a specific area for avoiding, the third icon indicates selecting a first area for multiple cleanings, and the fourth icon indicates selecting a second area for prioritized cleaning.

Further, after the user selects the icon to determine the type of area, a touch operation may be performed to define the extent of the area, and a corresponding control instruction is then generated. The touch operation that defines the extent of the area may refer to the description of the above embodiments and will not be described in detail herein.

In some other embodiments, which type of area is selected for the corresponding action may be determined by means of frame selection operations of different shapes. For example, a circular frame selection operation indicates selecting a designated area for supplementary cleaning, a rectangular frame selection operation indicates selecting a specific area for avoiding, a triangular frame selection operation indicates selecting a first area for multiple cleanings, and a hexagonal frame selection operation indicates selecting a second area for prioritized cleaning. Thus, after the user selects the shape-based frame selection area to determine the type of area, a touch operation may be performed to define the extent of the area, and a corresponding control instruction is then generated. The touch operation that defines the extent of the area may refer to the description of the above embodiments and will not be described in detail herein.

It should be noted that the operation of the user to select the type of area is not specifically limited in the embodiments of the present application. The above is merely illustrative.

In this way, for different cleaning requirements of the user, the type of control instruction generated can be determined by selecting the type of area to be cleaned or avoided on the display interface of the smart terminal, to control the cleaning device to perform different actions.

The embodiments of the present application further provide a schematic structural view of an electronic device. FIG. 10 is a schematic structural view of an electronic device according to an embodiment of the present application. As shown in FIG. 10, the electronic device 1000 may include: a processor 1001 and a memory 1002 communicatively connected to the processor 1001. The memory 1002 is configured to store a computer program. The processor 1001 executes the computer program stored in the memory 1002, to cause the processor 1001 to perform the method in any one of the foregoing embodiments.

The memory 1002 and the processor 1001 may be connected through a bus 1003.

An embodiment of the present application further provides a non-transitory computer-readable storage medium. The non-transitory computer-readable storage medium stores computer-executable instructions. The computer-executable instructions, when executed by a processor, are configured to implement the method in any one of the foregoing embodiments of the present application.

An embodiment of the present application further provides a chip for running instructions. The chip is configured to perform the method in any one of the foregoing embodiments performed by an electronic device in any one of the foregoing embodiments of the present application.

An embodiment of the present application further provides a computer program product. The computer program product includes a computer program. The computer program, when executed by a processor, can implement the method in any one of the foregoing embodiments performed by an electronic device in any one of the foregoing embodiments of the present application.

In the plurality of embodiments provided in the present application, the disclosed apparatus and method may be implemented in another manner. For example, the apparatus embodiment described above is merely an example. For example, the module division is merely logical function division and may be other division during actual implementation. For example, a plurality of modules or components may be combined or integrated into another system, or some features may be ignored or not performed. In addition, the displayed or discussed mutual coupling, direct coupling, or communicative connection may be implemented through some interfaces. The indirect coupling or communicative connection between the apparatuses or modules may be implemented in electrical, mechanical, or other forms.

The modules described as separate components may or may not be physically separate, and components displayed as modules may or may not be physical units. They may be located in one position, or may be distributed on a plurality of network units. Some or all of the modules may be selected based on an actual need to achieve the solutions of the embodiments.

In addition, the functional modules in the embodiments of the present application may be integrated into one processing unit, or each of the modules may exist alone physically, or two or more modules may be integrated into one unit. The unit integrated by the foregoing modules may be implemented in a form of hardware, or may be implemented in a form of a combination of hardware and a software functional unit.

The integrated modules implemented in the form of a software functional module may be stored in a computer-readable storage medium. The software functional module is stored in a storage medium and includes instructions for causing a computer device (which may be a personal computer, a server, a network device, or the like) or a processor to perform part of the steps of the method in the embodiments of the present application.

It should be understood that the processor may be a central processing unit (CPU), or may be another general purpose processor, a digital signal processor (DSP), an application specific integrated circuit (ASIC), or the like. The general purpose processor may be a microprocessor, or the processor may be any conventional processor or the like. The steps of the method disclosed in combination with the present application may be implemented directly by a hardware processor or by a combination of hardware and software modules in the processor.

The memory may include a high-speed random access memory (RAM), or may further include a non-volatile memory (NVM), for example, at least one disk memory, a USB flash disk, a removable hard disk, a read-only memory, a magnetic disk or an optical disk, or the like.

The bus may be an industry standard architecture (ISA) bus, a peripheral component interconnect (PCI) bus, an extended industry standard architecture (EISA) bus, or the like. The bus may be classified into an address bus, a data bus, a control bus, and the like. For convenience of illustration, the bus in the drawings of the present application does not represent only one bus or one type of bus.

The foregoing storage medium may be implemented by any type of volatile or non-volatile storage device or a combination thereof, such as a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk. The storage medium be any available medium that is accessible to a general purpose or special purpose computer.

An example storage medium is coupled to the processor, enabling the processor to read information from and write information to the storage medium. Certainly, the storage medium may alternatively be a part of the processor. The processor and the storage medium may be located in an application specific integrated circuit (ASIC). Certainly, the processor and the storage medium may alternatively exist as discrete components in an electronic device or a master device.

It should be noted that, for brevity, the foregoing method embodiments are described as a series of action combinations. However, a person skilled in the art is to be aware that the present application is not limited to the order of the described actions, because some steps may be performed in another order or simultaneously according to the present application. In addition, a person skilled in the art is further to be aware that the embodiments described in the specification are optional embodiments, and the involved actions and modules are not necessarily needed in the present application.

It should be further noted that, although each step in the flowchart is displayed in succession as indicated by an arrow, these steps are not necessarily performed in succession in the order indicated by the arrow. Unless otherwise explicitly stated herein, an execution order of these steps is not strictly limited, and these steps may be performed in another order. Moreover, at least part of the steps in the flowcharts may include a plurality of sub-steps or a plurality of stages. These sub-steps or stages are unnecessarily executed at the same moment, but instead may be executed at different moments. These sub-steps or stages are unnecessarily sequentially executed, but instead may be executed sequentially or alternately with other steps or at least part of sub-steps or stages of the other steps.

In the foregoing embodiments, the description of the embodiments has respective focuses. For a part that is not described in detail in an embodiment, reference may be made to related descriptions in other embodiments. The technical features of the foregoing embodiments may be combined arbitrarily. To make description concise, not all possible combinations of the technical features of the foregoing embodiments are described. However, the combinations of these technical features shall be considered as falling within the scope of this specification provided that no conflict exists.

A person skilled in the art may easily figure out another implementation of the present application after considering the specification and practicing the disclosure disclosed herein. The present application is intended to cover any variations, usage, or adaptive changes of the present application. These variations, use, or adaptive changes follow the general principles of the present application and include common knowledge or common technical means in the art which are not disclosed in the present application. The specification and embodiments are merely considered as examples, and the actual scope and spirit of the present application are pointed out in the following claims.

The foregoing is merely a detailed description of the embodiments of the present application, but the scope of protection of the embodiments of the present application is not limited thereto. Any variations or replacements made within the scope of the technology disclosed in the embodiments of the present application should be covered by the scope of protection of the embodiments of the present application. Therefore, the scope of protection of the present application shall be subject to the scope of protection of the claims.

What is claimed is:

1. A cleaning device control method for a controller of a cleaning device, the cleaning device control method comprising:
receiving a first control instruction during execution of a current cleaning task, wherein the first control instruction is an instruction for performing supplementary cleaning on a designated area within a work area which has been cleaned in the current cleaning task, the designated area is an area defined on a display interface of a smart terminal, and the smart terminal is communicatively connected to the cleaning device; and
controlling, on the basis of the first control instruction, the cleaning device to travel to the designated area to perform supplementary cleaning on the designated area.

2. The cleaning device control method according to claim 1, further comprising:
controlling, upon completion of the supplementary cleaning of the designated area, the cleaning device to continue to travel to a work area, which has not been cleaned during the current cleaning task, to perform cleaning;
wherein the designated area is an area where the degree of soiling is greater than a preset threshold.

3. The cleaning device control method according to claim 1, wherein the cleaning device comprises a cleaning assembly and a main body; the cleaning assembly has a first position and a second position; a part of the cleaning assembly that is located outside a peripheral side of the main body when in the second position is larger than a part of the cleaning assembly that is located outside the peripheral side of the main body when in the first position; the designated area is an area where the cleaning assembly of the cleaning device does not enter when in the second position; and controlling, on the basis of the first control instruction, the cleaning device to travel to the designated area to perform supplementary cleaning on the designated area comprises:
controlling, on the basis of the first control instruction, the cleaning device to travel to the designated area, and controlling the cleaning assembly of the cleaning device to switch from the second position to the first position to perform supplementary cleaning on the designated area.

4. The cleaning device control method according to claim 1, wherein performing supplementary cleaning on the designated area comprises:
receiving a supplementary cleaning strategy sent by the smart terminal, or identifying cleaning requirements for the designated area and determining a supplementary cleaning strategy on the basis of the cleaning requirements; and
performing supplementary cleaning on the designated area on the basis of the supplementary cleaning strategy;
wherein the first control instruction is a one-shot control instruction.

5. The cleaning device control method according to claim 1, further comprising:
storing the first control instruction, so as to directly invoke the first control instruction the next time the designated area is encountered.

6. A cleaning device control method for a controller of a cleaning device, the cleaning device control method comprising:
receiving a second control instruction during execution of a current cleaning task, wherein the second control instruction is an instruction for a smart terminal to avoid a specific area, the specific area is an area defined on a display interface of the smart terminal that does not require cleaning, and the smart terminal is communicatively connected to the cleaning device; and
controlling, on the basis of the second control instruction, the cleaning device to avoid the specific area.

7. The cleaning device control method according to claim 6, wherein the second control instruction is a one-shot control instruction;
the method further comprises:
storing the second control instruction, so as to directly invoke the second control instruction the next time the specific area is encountered.

8. A cleaning device control method for a controller of a cleaning device, the cleaning device control method comprising:
receiving a third control instruction during execution of a current cleaning task, wherein the third control instruction is an instruction for performing focused cleaning on a first area, the first area is an area defined on a display interface of the smart terminal that requires intensified cleaning, and is an area being cleaned or an uncleaned area, and the smart terminal is communicatively connected to the cleaning device; and
controlling, on the basis of the third control instruction, the cleaning device to clean the first area a plurality of times.

9. The cleaning device control method according to claim 8, wherein the third control instruction is a one-shot control instruction;
the method further comprises:
storing the third control instruction, so as to directly invoke the third control instruction the next time the first area is encountered.

10. A cleaning device control method for a controller of a cleaning device, the cleaning device control method comprising:
receiving a fourth control instruction during execution of a current cleaning task, wherein the fourth control instruction is an instruction for a smart terminal to perform temporary cleaning on a second area, the second area is an area defined on a display interface of a smart terminal, and the smart terminal is communicatively connected to the cleaning device; and
controlling, on the basis of the fourth control instruction, the cleaning device to perform temporary cleaning on the second area.

11. The cleaning device control method according to claim 10, wherein the fourth control instruction is a one-shot control instruction;
the method further comprises:
storing the fourth control instruction, so as to directly invoke the fourth control instruction the next time the second area is encountered.

12. The cleaning device control method according to claim 10, wherein controlling, on the basis of the fourth control instruction, the cleaning device to perform temporary cleaning on the second area comprises:
determining a third area corresponding to the execution of the current cleaning task, the third area comprising at least an uncleaned area;
determining the second area for temporary cleaning on the basis of the fourth control instruction; and
adjusting a cleaning sequence to prioritize the second area over the third area, so as to perform temporary cleaning on the second area.

13. The cleaning device control method according to claim 8, wherein performing temporary cleaning on the second area comprises:
receiving a cleaning strategy sent by the smart terminal, and performing temporary cleaning on the second area on the basis of the cleaning strategy, the cleaning strategy being determined on the basis of temporary requirements from a user.

14. The cleaning device control method according to claim 1, wherein the defined area is determined by a touch operation of a user on the display interface of the smart terminal, the touch operation comprising any one of the following: a frame selection operation, a single tap operation, a double tap operation, a long press operation, a swipe operation, a drag and drop operation, and a multi-finger operation.

15. The cleaning device control method according to claim 1, wherein the display interface comprises at least a cleaning map; the cleaning map comprises a plurality of cleaning areas; and each cleaning area is capable of displaying a cleaning status for a user to view.

16. A cleaning device, comprising: a controller for executing the cleaning device control method of claim 1, a cleaning assembly, and a main body.

17. A cleaning device control system, comprising: a cleaning device and a smart terminal, wherein the cleaning device comprises a controller for executing the cleaning device control method of claim 1;
the smart terminal is communicatively connected to the cleaning device; and the smart terminal is configured to send a control instruction to the controller;

18. The cleaning device control system according to claim 17, wherein the control instruction is determined from a type of area selected by a user on a display interface of the smart terminal.

19. An electronic device, comprising: a processor, and a memory communicatively connected to the processor, wherein
the memory is configured to store computer-executable instructions; and
the processor is configured to execute the computer-executable instructions stored in the memory, to implement the cleaning device control method of claim 1.

20. A non-transitory computer-readable storage medium, storing computer-executable instructions, wherein the computer-executable instructions, when executed by a processor, are configured to implement the cleaning device control method of claim 1.
